(19) United States
(12) Patent Application Publication
(10) Pub. No.: US 2019/0073132 A1
(43) Pub. Date: Mar. 7, 2019

(54) METHOD AND SYSTEM FOR ACTIVE PERSISTENT STORAGE VIA A MEMORY BUS

(71) Applicant: Alibaba Group Holding Limited, Grand Cayman (KY)

(72) Inventors: Ping Zhou, Folsom, CA (US); Shu Li, Bothell, WA (US)

(73) Assignee: Alibaba Group Holding Limited, Grand Cayman (KY)

(21) Appl. No.: 15/696,027

(22) Filed: Sep. 5, 2017

(51) Int. Cl. G06F 3/06

(52) U.S. Cl. CPC G06F 3/0608; G06F 3/0688; G06F 3/0641; G06F 3/065; G06F 3/0659

(57) ABSTRACT

One embodiment facilitates an active persistent memory. During operation, the system receives, by a non-volatile memory of a storage device via a memory bus, a command to manipulate data on the non-volatile memory, wherein the memory bus is connected to a volatile memory. The system executes, by a controller of the non-volatile memory, the command.

### BACKGROUND

### Field

This disclosure is generally related to the field of data storage. More specifically, this disclosure is related to a method and system for active persistent storage via a memory bus.

### Related Art

The proliferation of the Internet and e-commerce continues to create a vast amount of digital content. Various storage systems have been created to access and store such digital content. In a traditional server in a storage system, the central processing unit (CPU) may be connected to a volatile memory (such as a Dynamic Random Access Memory (DRAM) Dual In-line Memory Module (DIMM)) via a memory bus, and may further be connected to a non-volatile memory (such as peripheral storage devices, solid state drives, and NAND flash memory) via other protocols. For example, the CPU may be connected to a Peripheral Component Interconnect express (PCIe) device like a NAND solid state drive (SSD) using a PCIe or Non-Volatile Memory express (NVMe) protocol. The CPU may also be connected to a hard disk drive (HDD) using a Serial AT Attachment (SATA) protocol. Volatile memory (i.e., DRAM) may be referred to as “memory” and typically involves high performance and low capacity, while non-volatile memory (i.e., SSD/HDD) may be referred to as “storage” and typically involves high capacity but lower performance than DRAM.

Storage class memory (SCM) is a hybrid storage/memory, which both connects to memory slots in a motherboard (like traditional DRAM) and provides persistent storage (like traditional SSD/HDD non-volatile storage where data is retained despite power loss). Mapping SCM directly into system address space can provide a uniform memory I/O interface to applications, and can allow applications to adopt SCM without significant changes. However, accessing persistent memory in address space can introduce some challenges. Operations which involve moving, copying, scanning, or manipulating large chunks of data may cause cache pollution, whereby useful data may be evicted by these operations. This can result in a decrease in efficiency (e.g., lower performance). In addition, because persistent memory typically has a much higher capacity than DRAM, the cache pollution problem may create an even more significant challenge with the use of persistent storage. Furthermore, because persistent memory is typically slower than DRAM, the operations (e.g., manipulating large chunks of data) may occupy a greater number of CPU cycles. Thus, while SCM includes benefits of both storage and memory, several challenges exist which may decrease the efficiency of a system.

### SUMMARY

One embodiment facilitates an active persistent memory. During operation, the system receives, by a non-volatile memory of a storage device via a memory bus, a command to manipulate data on the non-volatile memory, wherein the memory bus is connected to a volatile memory. The system executes, by a controller of the non-volatile memory, the command.

In some embodiments, the command is received by the controller. The system receives, by the controller, a request for a status of the executed command. The system generates, by the controller, a response to the request for the status based on whether the command has completed.

In some embodiments, the request for the status is received from the central processing unit. Executing the command, by the controller, causes the central processing unit to continue performing operations which do not involve manipulating the data on the non-volatile memory.

In some embodiments, the command to manipulate the data on the non-volatile memory indicates one or more of: a command to copy data from a source address to a destination address; a command to fill a region of the non-volatile memory with a first value; a command to scan a region of the non-volatile memory for a second value, and, in response to determining an offset, return the offset; and a command to add or subtract a third value to or from each word in a region of the non-volatile memory.

In some embodiments, the command to manipulate the data on the non-volatile memory includes one or more of: an operation code which identifies the command; and a parameter specific to the command.

In some embodiments, the parameter includes one or more of: a source address; a destination address; a starting address; an ending address; a length of the data to be manipulated; and a value associated with the command.

In some embodiments, the source address is a logical block address associated with the data to be manipulated, and the destination address is a physical block address of the non-volatile memory.

### BRIEF DESCRIPTION OF THE FIGURES

FIG. 1A illustrates an exemplary environment that facilitates an active persistent memory, in accordance with an embodiment of the present application.

FIG. 1B illustrates an exemplary environment for storing data in the prior art.

FIG. 1C illustrates an exemplary environment that facilitates an active persistent memory, in accordance with an embodiment of the present application.

FIG. 2 illustrates an exemplary table of complex memory operation commands, in accordance with an embodiment of the present application.

FIG. 3 presents a flowchart illustrating a method for executing a complex memory operation command in the prior art.

FIG. 4 presents a flowchart illustrating a method for executing a complex memory operation command, in accordance with an embodiment of the present application.

FIG. 5 illustrates an exemplary computer system that facilitates an active persistent memory, in accordance with an embodiment of the present application.

FIG. 6 illustrates an exemplary apparatus that facilitates an active persistent memory, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

The embodiments described herein solve the problem of increasing the efficiency in a storage class memory by offloading execution of complex memory operations (which currently require CPU involvement) to an active and non-volatile memory via a memory bus. The system offloads the complex memory operations to a controller of the “active persistent memory,” which allows the CPU to continue performing other operations and results in an increased efficiency for the storage class memory.

Storage class memory (SCM) is a hybrid storage/memory, with an access speed close to memory (i.e., volatile memory) and a capacity close to storage (i.e., non-volatile memory). An application may map SCM directly to system address space in a “persistent memory” mode, which can provide a uniform memory I/O interface to the application, allowing the application to adopt SCM without significant changes. However, accessing persistent memory in address space can introduce some challenges. Complex operations which involve moving, copying, scanning, or manipulating large chunks of data may cause cache pollution, whereby useful data may be evicted by these operations. This can result in a decrease in efficiency (e.g., lower performance). In addition, because persistent memory typically has a much higher capacity than DRAM, the cache pollution problem may create an even more significant challenge with the use of persistent storage. Furthermore, because persistent memory is typically slower than DRAM, performance of these complex operations (e.g., manipulating large chunks of data) may occupy a greater number of CPU cycles, which can also decrease the efficiency of a system.

The embodiments described herein address these challenges by offloading the execution of the complex memory operations to a controller of the storage class memory. Volatile memory (e.g., DRAM DIMM) is traditionally assumed to be a “dumb and passive” device which can only process simple, low-level read/write commands from the CPU. This is because DRAM DIMM is mostly a massive array of cells with some peripheral circuits. Complex, higher-level operations, such as “copy 4 MB from address A to address B” or “subtract X from every 64-bit word in a certain memory region,” must be handled by the CPU.

In contrast, SCM includes an on-DIMM controller to manage the non-volatile media. This controller is typically responsible for tasks like wear-leveling, error-handling, and background/reactive refresh operations, and may be an embedded system on a chip (SoC) with firmware. This controller allows SCM-based persistent memory to function as an “intelligent and active” device which can handle the complex, higher-level memory operations without the involvement of the CPU. Thus, in the embodiments described herein, the active persistent memory can serve not only simple read/write instructions, but can also handle the more complex memory operations which currently require CPU involvement. By eliminating the CPU involvement in manipulating data and handling the more complex memory operations, the system can decrease both the cache pollution and the number of CPU cycles required. This can result in an improved efficiency and performance.

Thus, the embodiments described herein provide a system which improves the efficiency of a storage system, where the improvements are fundamentally technological. The improved efficiency can include an improved performance in latency for, e.g., completion of I/O tasks, by reducing cache pollution and CPU occupation. The system provides a technological solution (i.e., offloading complex memory operations which typically require CPU involvement to a controller of a storage class memory) to the technological problem of reducing latency and improving the overall efficiency of the system.

The term “storage server” refers to a server which can include multiple drives and multiple memory modules.

The term “storage class memory” or “SCM” is a hybrid storage/memory which can provide an access speed close to memory (i.e., volatile memory) and a capacity close to storage (i.e., non-volatile memory). An application may map SCM directly to system address space in a “persistent memory” mode, which can provide a uniform memory I/O interface to the application, allowing the application to adopt SCM without significant changes. An application may also access SCM in a “block device” mode, using a block I/O interface such as Non-Volatile Memory Express (NVMe) protocol.

The term “active persistent memory” or “active persistent storage” refers to a device, as described herein, which includes a non-volatile memory with a controller or a controller module. In the embodiments described herein, active persistent memory is a storage class memory.

The term “volatile memory” refers to computer storage which can lose data quickly upon removal of the power source, such as DRAM. Volatile memory is generally located physically proximal to a processor and accessed via a memory bus.

The term “non-volatile memory” refers to long-term persistent computer storage which can retain data despite a power cycle or removal of the power source. Non-volatile memory is generally located in an SSD or other peripheral component and accessed over a serial bus protocol. However, in the embodiments described herein, non-volatile memory is storage class memory or active persistent memory, which is accessed over a memory bus.

The terms “controller module” and “controller” refer to a module located on an SCM or active persistent storage device. In the embodiments described herein, the controller handles complex memory operations which are offloaded to the SCM by the CPU.

### Exemplary System

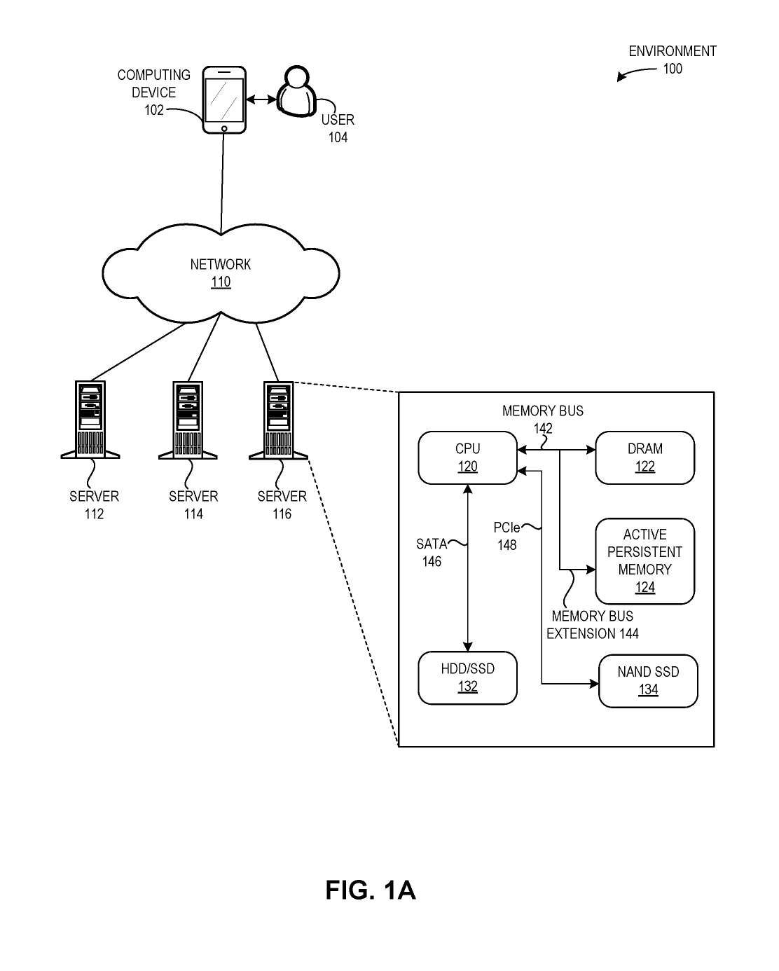

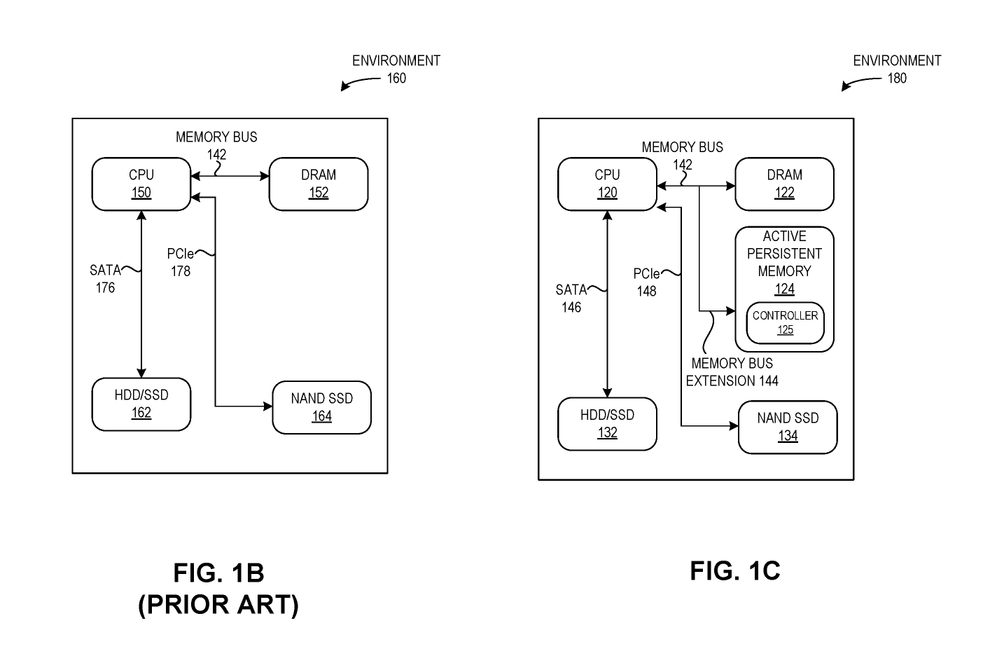

FIG. 1A illustrates an exemplary environment 100 that facilitates an active persistent memory, in accordance with an embodiment of the present application. Environment 100 can include a computing device 102 which is associated with a user 104. Computing device 102 can include, for example, a tablet, a mobile phone, an electronic reader, a laptop computer, a desktop computer, or any other computing device. Computing device 102 can communicate via a network 110 with servers 112, 114, and 116, which can be part of a distributed storage system. Servers 112-116 can include a storage server, which can include a CPU connected via a memory bus to both volatile memory and non-volatile memory. The non-volatile memory is an active persistent memory which can be a storage-class memory including features for both an improved memory (e.g., with an access speed close to a speed for accessing volatile memory) and an improved storage (e.g., with a storage capacity close to a capacity for standard non-volatile memory).

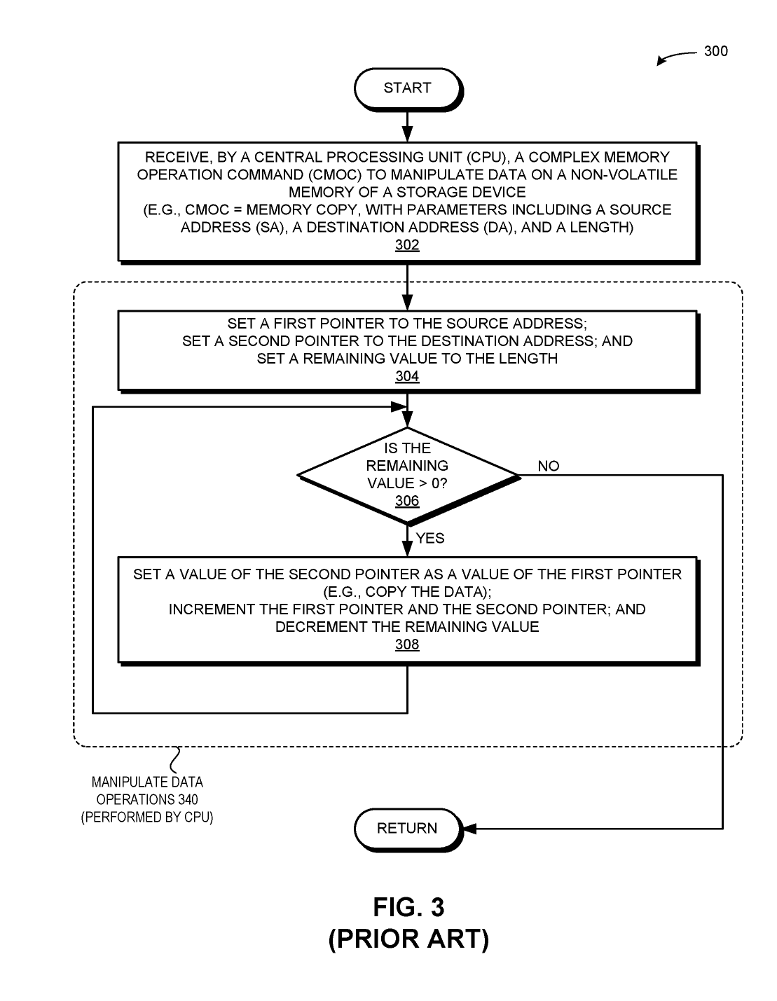

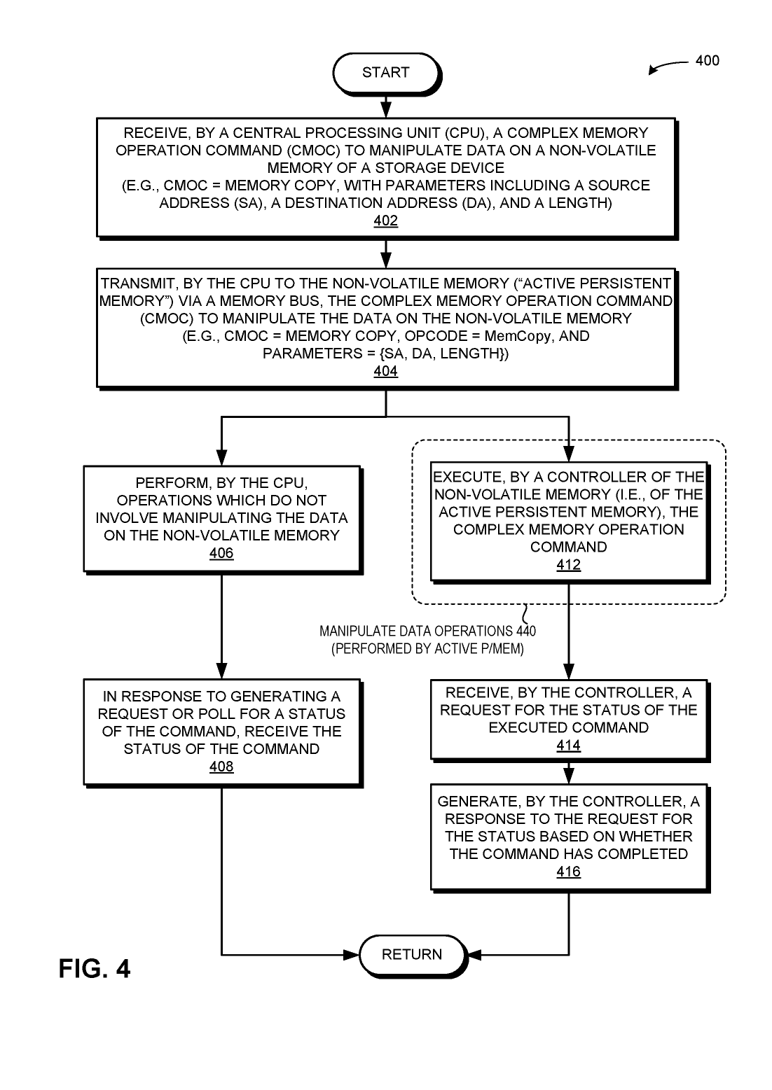

For example, server 116 can include a CPU 120 which is connected via a memory bus 142 to a volatile memory (DRAM) 122, and is also connected via a memory bus extension 144 to a non-volatile memory (active persistent memory) 124. CPU 120 can also be connected via a Serial AT Attachment (SATA) protocol 146 to a hard disk drive/solid state drive (HDD/SDD) 132, and via a Peripheral Component Interconnect Express (PCIe) protocol 148 to a NAND SSD 134. Server 116 depicts a system which facilitates an active persistent memory via a memory bus (e.g., active persistent memory 124 via memory bus extension 144). A general data flow in the prior art is described below in relation to FIG. 3, and an exemplary data flow in accordance with an embodiment of the present application is described below in relation to FIG. 4.

Exemplary Environment in the Prior Art Vs. Exemplary Embodiment

FIG. 1B illustrates an exemplary environment 160 for storing data in the prior art. Environment 160 can include a CPU 150, which can be connected to a volatile memory (DRAM) 152. CPU 150 can also be connected via a SATA protocol 176 to an HDD/SDD 162, and via a PCIe protocol 178 to a NAND SSD 164.

FIG. 1C illustrates an exemplary environment 180 that facilitates an active persistent memory, in accordance with an embodiment of the present application. Environment 180 is similar to server 116 of FIG. 1A, and different from prior art environment 160 of FIG. 1B in the following manner: environment 180 includes active persistent memory 124 connected via memory bus extension 144. CPU 120 can thus offload the execution of any complex memory operation commands that involve manipulating data on active persistent memory 124 to a controller 125 of active persistent memory 124. Controller 125 can be software or firmware or other circuitry-related instructions for a module embedded in the non-volatile storage of active persistent memory 124.

Thus, the embodiments described herein include an active persistent memory (i.e., a non-volatile memory) connected to the CPU via a memory bus extension. This allows the CPU to offload any complex memory operations to (a controller of) the active persistent memory. The active persistent memory described herein is a storage class memory which improves upon the dual advantages of both storage and memory. By coupling the storage-class memory directly to the CPU via the memory bus, environment 180 can provide an improved efficiency and performance (e.g., lower latency) over environment 160.

### Exemplary Table of Complex Memory Operation Commands

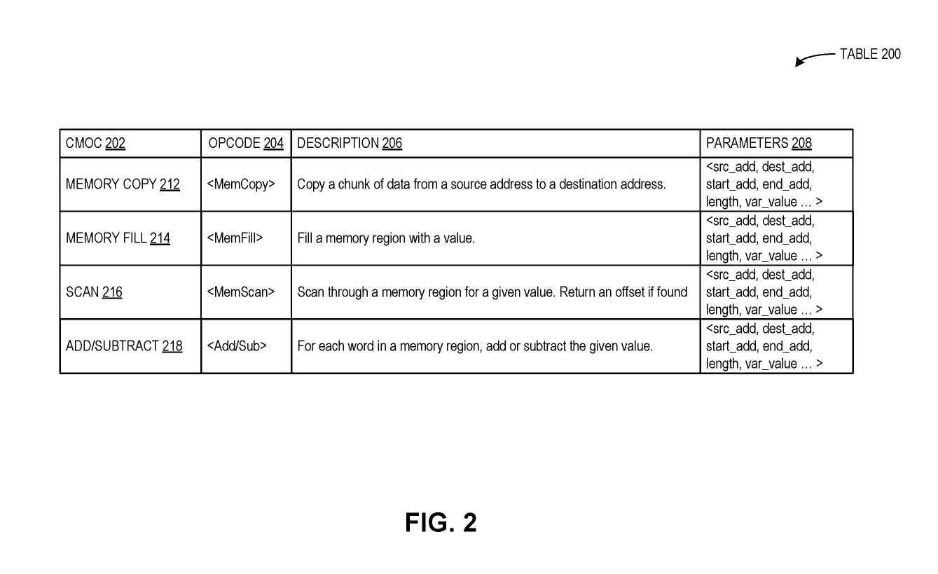

FIG. 2 illustrates an exemplary table 200 of complex memory operation commands, in accordance with an embodiment of the present application. Table 200 includes entries with a CMOC 202, an operation code 204, a description 206, and parameters 208. Parameters 208 can include one or more of: a source address (“src_add”); a destination address (“dest_add”); a start address (“start_add”); an end address (“end_add”); a length (“length”); and a value for variable (“var_value”). The parameters may be indicated or included in a command based on the type of command. For example, in an “add” operation, the parameters can include a variable value X to subtract from each of 64-bit word in a memory region from start_add to end_add. As another example, in a “memory copy” operation, the parameters can include a src_add, a dest_add, and a length.

A memory copy 212 CMOC can include an operation code of “MemCopy,” and can copy a chunk of data from a source address to a destination address. A memory fill 214 CMOC can include an operation code of “MemFill,” and can fill a memory region with a value. A scan 216 CMOC can include an operation code of “MemScan,” and can scan through a memory region for a given value, and return an offset if found. An add/subtract 218 CMOC can include an operation code of “Add/Sub,” and, for each word in a memory region, add or subtract a given value (e.g., as indicated in the parameters).

### Method for Executing a CMOC in the Prior Art

FIG. 3 presents a flowchart illustrating a method 300 for executing a complex memory operation command in the prior art. During operation, the system receives, by a central processing unit (CPU), a complex memory operation command (CMOC) to manipulate data on a non-volatile memory of a storage device (operation 302). A CMOC may be, for example, a memory copy command, with parameters including a source address (SA), a destination address (DA), and a length. The CPU sets a first pointer to the source address, sets a second pointer to the destination address, and sets a remaining value to the length (operation 304). If the remaining value is greater than zero (decision 306), the CPU: sets a value of the second pointer as a value of the first pointer (e.g., copies the data); increments the first pointer and the second pointer; and decrements the remaining value (operation 308). The operation returns to decision 306.

If the remaining value is not greater than zero (decision 306), the operation returns. In FIG. 3, a set of manipulate data operations 340 (i.e., operations 304, 306, and 308) is performed by the CPU.

### Method for Executing a CMOC in an Exemplary Embodiment

FIG. 4 presents a flowchart illustrating a method 400 for executing a complex memory operation command, in accordance with an embodiment of the present application. During operation, the system receives, by a CPU, a complex memory operation command (CMOC) to manipulate data on a non-volatile memory of a storage device (operation 402). A CMOC may be, for example, a memory copy command, with parameters including a source address (SA), a destination address (DA), and a length. The system transmits, by the CPU to the non-volatile memory (“active persistent memory”) via a memory bus, the complex memory operation command to manipulate the data on the non-volatile memory (operation 404). For example, the CMOC may be a memory copy, with an operation code of “MemCopy,” and parameters including “{SA, DA, length}.” The CPU thus offloads execution of the complex memory operation command to the active persistent memory. That is, the system executes, by a controller of the non-volatile memory (i.e., of the active persistent memory), the complex memory operation command (operation 412), wherein executing the command is not performed by the CPU. The controller may perform a set of manipulate data operations 440 (similar to operations 304, 306, and 308, which were previously performed by the CPU, as shown in FIG. 3). At the same time that the controller is performing manipulate data operations 440 (i.e., executing the complex memory operation command), the CPU performs operations which do not involve manipulating the data on the non-volatile memory (operation 406).

Subsequently, the CPU can poll the active persistent memory for a status of the completion of the complex memory operation command. For example, in response to generating a request or poll for a status of the command, the CPU receives the status of the command (operation 408). From the controller perspective, the system receives, by the controller, a request for the status of the executed command (operation 414). The system generates, by the controller, a response to the request for the status based on whether the command has completed (operation 416).

### Exemplary Computer System and Apparatus

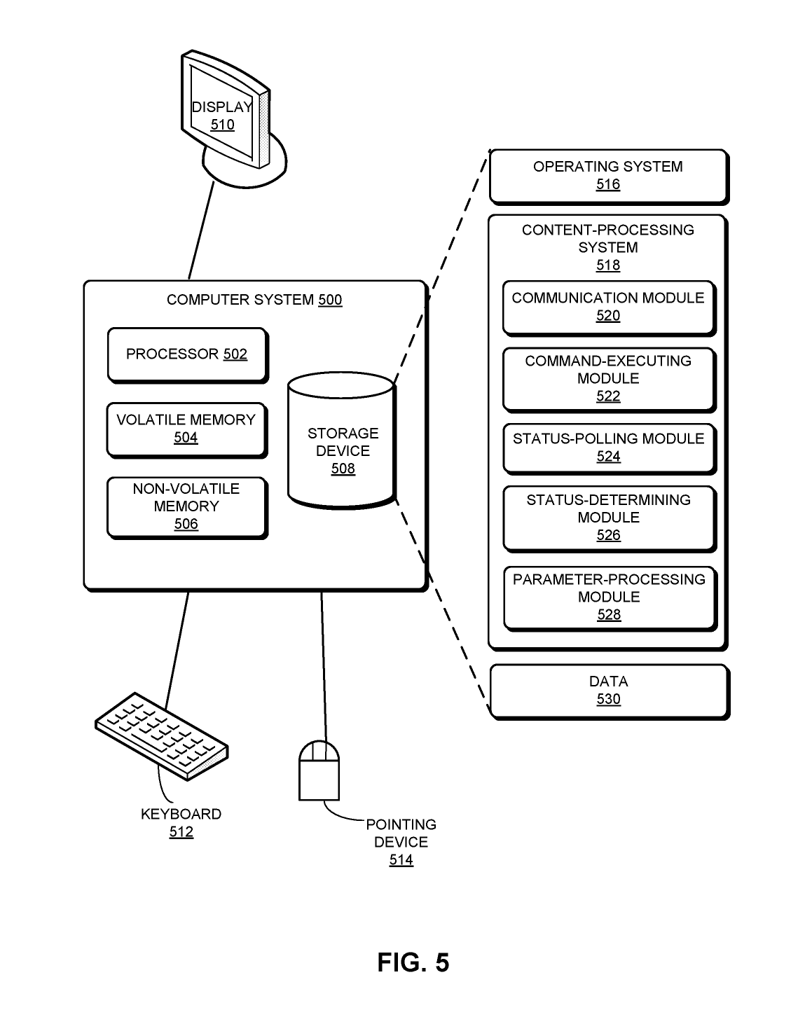

FIG. 5 illustrates an exemplary computer system 500 that facilitates an active persistent memory, in accordance with an embodiment of the present application. Computer system 500 includes a processor 502, a volatile memory 504, a non-volatile memory 506, and a storage device 508. Computer system 500 may be a client-serving machine. Volatile memory 504 can include, e.g., RAM, that serves as a managed memory, and can be used to store one or more memory pools. Non-volatile memory 506 can include an active persistent storage that is accessed via a memory bus. Furthermore, computer system 500 can be coupled to a display device 510, a keyboard 512, and a pointing device 514. Storage device 508 can store an operating system 516, a content-processing system 518, and data 530.

Content-processing system 518 can include instructions, which when executed by computer system 500, can cause computer system 500 to perform methods and/or processes described in this disclosure. Specifically, content-processing system 518 can include instructions for receiving and transmitting data packets, including a command, a parameter, a request for a status of a command, and a response to the request for the status. Content-processing system 518 can further include instructions for receiving, by a non-volatile memory of a storage device via a memory bus, a command to manipulate data on the non-volatile memory, wherein the memory bus is connected to a volatile memory (communication module 520). Content-processing system 518 can include instructions for executing, by a controller of the non-volatile memory, the command (command-executing module 522 and parameter-processing module 528).

Content-processing system 518 can additionally include instructions for receiving, by the controller, the command (communication module 520), and receiving, by the controller, a request for a status of the executed command (communication module 520 and status-polling module 524). Content-processing system 518 can include instructions for generating, by the controller, a response to the request for the status based on whether the command has completed (status-determining module 526).

Content-processing system 518 can also include instructions for receiving the request for the status from the central processing unit (communication module 520 and status-polling module 524). Content-processing system 518 can include instructions for executing the command, by the controller, which causes the central processing unit to continue performing operations which do not involve manipulating the data on the non-volatile memory (command-executing module 522 and parameter-processing module 528).

Data 530 can include any data that is required as input or that is generated as output by the methods and/or processes described in this disclosure. Specifically, data 530 can store at least: data to be written, read, stored, or accessed; processed or stored data; encoded or decoded data; encrypted or compressed data; decrypted or decompressed data; a command; a status of a command; a request for the status; a response to the request for the status; a command to copy data from a source address to a destination address; a command to fill a region of the non-volatile memory with a first value; a command to scan a region of the non-volatile memory for a second value, and, in response to determining an offset, return the offset; a command to add or subtract a third value to or from each word in a region of the non-volatile memory; an operation code which identifies a command; a parameter; a parameter specific to a command; a source address; a destination address; a starting address; an ending address; a length; a value associated with a command; a logical block address; and a physical block address.

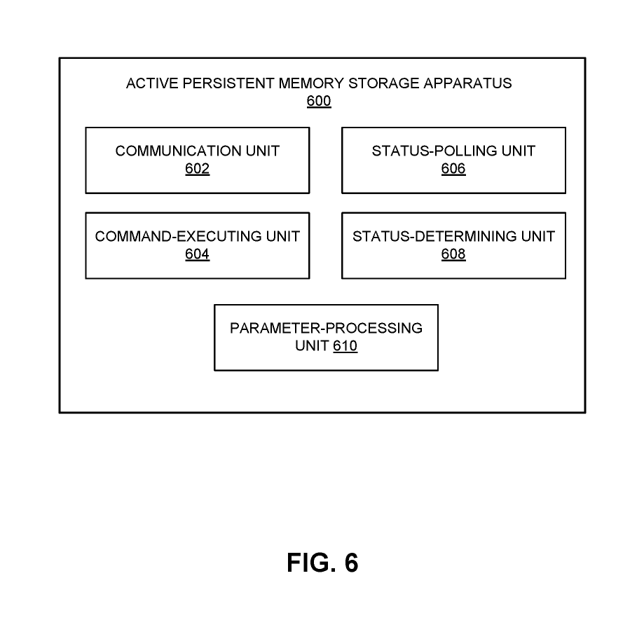

FIG. 6 illustrates an exemplary apparatus 600 that facilitates an active persistent memory, in accordance with an embodiment of the present application. Apparatus 600 can comprise a plurality of units or apparatuses which may communicate with one another via a wired, wireless, quantum light, or electrical communication channel. Apparatus 600 may be realized using one or more integrated circuits, and may include fewer or more units or apparatuses than those shown in FIG. 6. Further, apparatus 600 may be integrated in a computer system, or realized as a separate device which is capable of communicating with other computer systems and/or devices. Specifically, apparatus 600 can comprise units 602-610 which perform functions or operations similar to modules 520-528 of computer system 500 of FIG. 5, including: a communication unit 602; a command-executing unit 604; a status-polling unit 606; a status-determining unit 608; and a parameter-processing unit 610.

Furthermore, apparatus 600 can be a non-volatile memory (such as active persistent memory 124 of FIG. 1C), which includes a controller configured to: receive, via a memory bus, a command to manipulate data on the non-volatile memory, wherein the memory bus is connected to a volatile memory; and execute the command, wherein executing the command is not performed by a central processing unit. The controller may be further configured to: receive a request for a status of the executed command; and generate a response to the request for the status based on whether the command has completed.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. A computer-implemented method for facilitating an active persistent memory, the method comprising:
receiving, by a non-volatile memory of a storage device via a memory bus, a command to manipulate data on the non-volatile memory, wherein the memory bus is connected to a volatile memory; and
executing, by a controller of the non-volatile memory, the command.

2. The method of claim 1, wherein the command is received by the controller, and wherein the method further comprises:
receiving, by the controller, a request for a status of the executed command; and
generating, by the controller, a response to the request for the status based on whether the command has completed.

3. The method of claim 2, wherein the request for the status is received from the central processing unit, and
wherein executing the command, by the controller, causes the central processing unit to continue performing operations which do not involve manipulating the data on the non-volatile memory.

4. The method of claim 1, wherein the command to manipulate the data on the non-volatile memory indicates one or more of:
a command to copy data from a source address to a destination address;
a command to fill a region of the non-volatile memory with a first value;
a command to scan a region of the non-volatile memory for a second value, and, in response to determining an offset, return the offset; and
a command to add or subtract a third value to or from each word in a region of the non-volatile memory.

5. The method of claim 1, wherein the command to manipulate the data on the non-volatile memory includes one or more of:
an operation code which identifies the command; and
a parameter specific to the command.

6. The method of claim 5, wherein the parameter includes one or more of:
a source address;
a destination address;
a starting address;
an ending address;
a length of the data to be manipulated; and
a value associated with the command.

7. The method of claim 6, wherein the source address is a logical block address associated with the data to be manipulated, and
wherein the destination address is a physical block address of the non-volatile memory.

8. A computer system for facilitating an active persistent memory, the system comprising:
a processor; and
a memory coupled to the processor and storing instructions, which when executed by the processor cause the processor to perform a method, the method comprising:
receiving, by a non-volatile memory of the computer system via a memory bus, a command to manipulate data on the non-volatile memory, wherein the memory bus is connected to a volatile memory; and
executing, by a controller of the non-volatile memory, the command.

9. The computer system of claim 8, wherein the command is received by the controller, and wherein the method further comprises:
receiving, by the controller, a request for a status of the executed command; and
generating, by the controller, a response to the request for the status based on whether the command has completed.

10. The computer system of claim 9, wherein the request for the status is received from the central processing unit, and
wherein executing the command, by the controller, causes the central processing unit to continue performing operations which do not involve manipulating the data on the non-volatile memory.

11. The computer system of claim 8, wherein the command to manipulate the data on the non-volatile memory indicates one or more of:
a command to copy data from a source address to a destination address;
a command to fill a region of the non-volatile memory with a first value;
a command to scan a region of the non-volatile memory for a second value, and, in response to determining an offset, return the offset; and
a command to add or subtract a third value to or from each word in a region of the non-volatile memory.

12. The computer system of claim 8, wherein the command to manipulate the data on the non-volatile memory includes one or more of:
an operation code which identifies the command; and
a parameter specific to the command.

13. The computer system of claim 12, wherein the parameter includes one or more of:
a source address;
a destination address;
a starting address;
an ending address;
a length of the data to be manipulated; and
a value associated with the command.

14. The computer system of claim 13, wherein the source address is a logical block address associated with the data to be manipulated, and
wherein the destination address is a physical block address of the non-volatile memory.

15. A non-volatile memory, comprising:
a controller configured to receive, via a memory bus, a command to manipulate data on the non-volatile memory, wherein the memory bus is connected to a volatile memory; and
wherein the controller is further configured to execute the command.

16. The non-volatile memory of claim 15, wherein the controller is further configured to:
receive a request for a status of the executed command; and
generate a response to the request for the status based on whether the command has completed.

17. The non-volatile memory of claim 16, wherein the request for the status is received from the central processing unit, and
wherein executing the command, by the controller, causes the central processing unit to continue performing operations which do not involve manipulating the data on the non-volatile memory.

18. The non-volatile memory of claim 15, wherein the command to manipulate the data on the non-volatile memory indicates one or more of:
a command to copy data from a source address to a destination address;
a command to fill a region of the non-volatile memory with a first value;
a command to scan a region of the non-volatile memory for a second value, and, in response to determining an offset, return the offset; and
a command to add or subtract a third value to or from each word in a region of the non-volatile memory.

19. The non-volatile memory of claim 15, wherein the command to manipulate the data on the non-volatile memory includes one or more of:
an operation code which identifies the command; and
a parameter specific to the command.

20. The non-volatile memory of claim 19, wherein the parameter includes one or more of:
a source address;
a destination address;
a starting address;
an ending address;
a length of the data to be manipulated; and
a value associated with the command.
